(19) United States
(12) Patent Application Publication
(10) Pub. No.: US 2020/0042242 A1
(43) Pub. Date: Feb. 6, 2020

(54) CONTROLLER AND OPERATION METHOD THEREOF

(71) Applicant: SK hynix Inc., Gyeonggi-do (KR)

(72) Inventor: Eu-Joon BYUN, Gyeonggi-do (KR)

(21) Appl. No.: 16/281,213

(22) Filed: Feb. 21, 2019

(30) Foreign Application Priority Data
Jul. 31, 2018 (KR) 10-2018-0089102

(51) Int. Cl. G06F 3/06; G06F 12/10; G06F 12/0802

(52) U.S. Cl. CPC G06F 3/0659; G06F 3/0604; G06F 3/0673; G06F 2212/608; G06F 12/0802; G06F 2212/657; G06F 12/10

(57) ABSTRACT

Provided is an operation method of a controller which controls a memory device. The operation method may include: deriving an index corresponding to a logical address included in a read command based on the logical address and the number of indexes in a map cache table; and controlling the memory device to perform an operation corresponding to the read command by accessing a physical address corresponding to the logical address, depending on whether map data corresponding to the logical address are present in an entry corresponding to the derived index in the map cache table.

### CROSS-REFERENCE TO RELATED APPLICATION

This application claims priority under 35 U.S.C. § 119 to Korean Patent Application No. 10-2018-0089102, filed on Jul. 31, 2018, which is incorporated herein by reference in its entirety.

### BACKGROUND

### 1. Field

Various embodiments of the present invention generally relate to a controller. Particularly, the embodiments relate to a controller for controlling a memory device and an operation method thereof.

### 2. Discussion of the Related Art

Recently, the paradigm for the computing environment has shifted to ubiquitous computing, which enables computer systems to be used anytime anywhere. Therefore, the use of portable electronic devices such as mobile phones, digital cameras and notebook computers has rapidly increased. The portable electronic devices generally use a memory system having a memory device, that is, a data storage device. The data storage device is used as a main or secondary memory device of the portable electronic device.

Since the data storage device using a memory device has no mechanical driver, the data storage device has excellent stability and durability, high information access speed, and low power consumption. Data storage devices and associated memory systems having such advantages, include a universal serial bus (USB) memory device, a memory card having various interfaces, a solid state drive (SSD) and the like.

### SUMMARY

Various embodiments are directed to a controller which can improve read performance of memory system by reducing a map data search time, and an operation method thereof.

In an embodiment, there is provided an operation method of a controller which controls a memory device. The operation method may include: deriving an index corresponding to a logical address included in a read command based on the logical address and the number of indexes in a map cache table; and controlling the memory device to perform an operation corresponding to the read command by accessing a physical address corresponding to the logical address, depending on whether map data corresponding to the logical address are present in an entry corresponding to the derived index in the map cache table.

In an embodiment, there is provided an operation method of a controller which controls a memory device. The operation method may include: mapping a logical address included in a write command to a physical address of the memory device; determining an index corresponding to the logical address based on the logical address and the number of indexes in a map cache table; and caching map data corresponding to the performed mapping in an entry corresponding to the index; and controlling the memory device to perform a write operation corresponding to the write command.

In an embodiment, a controller for controlling a memory device may include: a map cache table suitable for caching map data based on a logical address and the number of indexes; and a processor suitable for deriving an index corresponding to a logical address included in a read command based on the logical address and the number of indexes in the map cache table, and controlling the memory device to perform an operation corresponding to the read command by accessing a physical address corresponding to the logical address, depending on whether map data corresponding to the logical address is present in an entry corresponding to the derived index.

In an embodiment, a controller for controlling a memory device may include: a map cache table; and a processor suitable for mapping a logical address included in a write command to a physical address of the memory device, determining an index corresponding to the logical address based on the logical address and the number of indexes in the map cache table, caching map data corresponding to the performed mapping in an entry corresponding to the index, and controlling the memory device to perform a write operation corresponding to the write command.

In an embodiment, a memory system may include: a memory device in which there are a plurality of logical addresses divided into chunks of equal size, each of which includes a distinct set of sequential logical addresses among the plurality of logical addresses; and a controller suitable for controlling the memory device, the controller comprising: a map cache table having a number of indexes; and a processor suitable for: determining an index, among the number of indexes, corresponding to a logical address in a command by dividing the logical address by the chunk size to determine a chunk number indicating to which chunk the logical address belongs and performing a modulo operation on the determined chunk number and the number of indexes in the map cache table, and caching map data corresponding to the logical address in entry corresponding to the determined indexes.

### BRIEF DESCRIPTION OF THE DRAWINGS

FIG. 1 is a block diagram illustrating a data processing system including a memory system in accordance with an embodiment of the present invention.

FIG. 2 is a diagram schematically illustrating an exemplary configuration of a memory device employed in the memory system of FIG. 1.

FIG. 3 is a circuit diagram illustrating an exemplary configuration of a memory cell array of a memory block in the memory device shown in FIG. 1.

FIG. 4 is a block diagram illustrating an exemplary three-dimensional structure of the memory device shown in FIG. 2.

FIG. 5 is a diagram that schematically illustrates the structure of a data processing system including a memory system in accordance with an embodiment of the present invention.

FIGS. 6 and 7 are flowcharts illustrating an operation method of a memory system in accordance with an embodiment of the present invention.

FIGS. 8 to 16 are diagrams that schematically illustrate other examples of a data processing system including the controller in accordance with various embodiments of the present invention.

### DETAILED DESCRIPTION

Various embodiments of the present disclosure will be described in detail with reference to the accompanying drawings. The following description focuses primarily on elements, features and operations of embodiments of the present invention. Well known technical detail not directly related to the present disclosure is omitted so as not to obscure the subject matter of the present disclosure.

Various embodiments are described below in more detail with reference to the accompanying drawings. Also, throughout the specification, reference to “an embodiment,” “another embodiment” or the like is not necessarily to only one embodiment, and different references to any such phrase are not necessarily to the same embodiment(s).

It will be understood that, although the terms “first”, “second”, “third”, and so on may be used herein to describe various elements, these elements are not limited by these terms. These terms are used to distinguish one element from another element. Thus, a first element described below could also be termed as a second or third element without departing from the spirit and scope of the present disclosure.

It will be further understood that when an element is referred to as being “connected to”, or “coupled to” another element, it may be directly on, connected to, or coupled to the other element, or one or more intervening elements may be present. In addition, it will also be understood that when an element is referred to as being “between” two elements, it may be the only element between the two elements, or one or more intervening elements may also be present. Communication between two elements, whether directly or indirectly connected/coupled, may be wired or wireless, unless stated or the context indicates otherwise.

As used herein, singular forms may include the plural forms as well and vice versa, unless the context clearly indicates otherwise.

It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

Hereinafter, the various embodiments of the present invention will be described in detail with reference to the attached drawings.

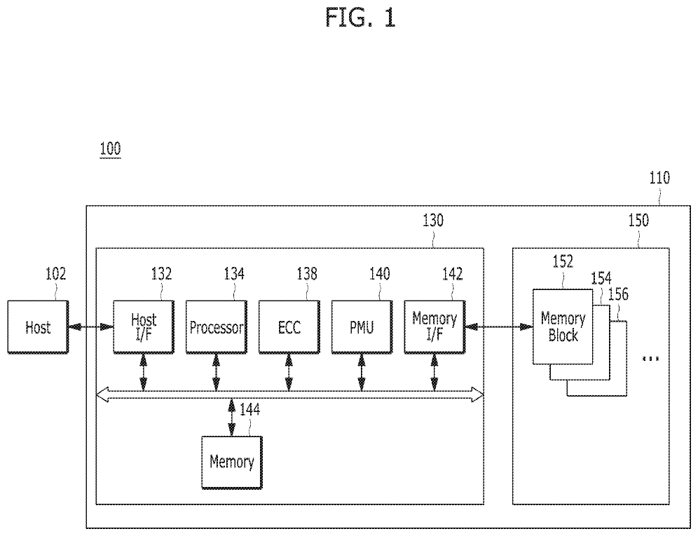

FIG. 1 is a block diagram illustrating a data processing system 100 in accordance with an embodiment of the present invention.

Referring to FIG. 1, the data processing system 100 may include a host 102 operatively coupled to a memory system 110.

The host 102 may include any of various portable electronic devices such as a mobile phone, MP3 player and laptop computer, or any of various non-portable electronic devices such as a desktop computer, a game machine, a television (TV), and a projector.

The host 102 may include at least one operating system (OS), which may manage and control overall functions and operations of the host 102, and provide operation between the host 102 and a user using the data processing system 100 or the memory system 110.

The OS may support functions and operations corresponding to the purpose and usage of a user. For example, the OS may be divided into a general OS and a mobile OS, depending on the mobility of the host 102. The general OS may be divided into a personal OS and an enterprise OS, depending on the environment of a user. For example, the personal OS configured to support a function of providing a service to general users may include Windows and Chrome, and the enterprise OS configured to secure and support high performance may include Windows server, Linux and Unix. Furthermore, the mobile OS configured to support a function of providing a mobile service to users and a power saving function of a system may include Android, iOS and Windows Mobile. The host 102 may include a plurality of OSs, and execute an OS to perform an operation corresponding to a user's request on the memory system 110.

The memory system 110 may operate to store data for the host 102 in response to a request of the host 102. Non-limiting examples of the memory system 110 include a solid state drive (SSD), a multi-media card (MMC), a secure digital (SD) card, a universal storage bus (USB) device, a universal flash storage (UFS) device, compact flash (CF) card, a smart media card (SMC), a personal computer memory card international association (PCMCIA) card and memory stick. The MMC may include an embedded MMC (eMMC), reduced size MMC (RS-MMC) and micro-MMC, and the. The SD card may include a mini-SD card and micro-SD card.

The memory system 110 may be embodied by any of various types of storage devices. Examples of such storage devices include, but are not limited to, volatile memory devices such as a DRAM dynamic random access memory (DRAM) and a static RAM (SRAM) and nonvolatile memory devices such as a read only memory (ROM), a mask ROM (MROM), a programmable ROM (PROM), an erasable programmable ROM (EPROM), an electrically erasable programmable ROM (EEPROM), a ferroelectric RAM (FRAM), a phase-change RAM (PRAM), a magneto-resistive RAM (MRAM), resistive RAM (RRAM or ReRAM) and a flash memory. The flash memory may have a 3-dimensional (3D) stack structure.

The memory system 110 may include a controller 130 and a memory device 150. The memory device 150 may store data for the host 102, and the controller 130 may control data storage into the memory device 150.

The controller 130 and the memory device 150 may be integrated into a single semiconductor device, which may be included in any of the various types of memory systems exemplified above. For example, the controller 130 and the memory device 150 may be integrated as one semiconductor device to constitute a solid state drive (SSD). When the memory system 110 is used as an SSD, the operating speed of the host 102 connected to the memory system 110 can be improved. In addition, the controller 130 and the memory device 150 may be integrated as one semiconductor device to constitute a memory card such as a personal computer memory card international association (PCMCIA) card, compact flash (CF) card, smart media (SM) card, memory stick, multimedia card (MMC) including reduced size MMC (RS-MMC) and micro-MMC, secure digital (SD) card including mini-SD, micro-SD and SDHC, and/or universal flash storage (UFS) device.

Non-limiting application examples of the memory system 110 include a computer, an Ultra Mobile PC (UMPC), a workstation, a net-book, a Personal Digital Assistant (PDA), a portable computer, a web tablet, a tablet computer, a wireless phone, a mobile phone, a smart phone, an e-book, a Portable Multimedia Player (PMP), a portable game machine, a navigation system, a black box, a digital camera, a Digital Multimedia Broadcasting (DMB) player, a 3-dimensional television, a smart television, a digital audio recorder, a digital audio player, a digital picture recorder, a digital picture player, a digital video recorder, a digital video player, a storage device constituting a data center, a device capable of transmitting/receiving information in a wireless environment, one of various electronic devices constituting a home network, one of various electronic devices constituting a computer network, one of various electronic devices constituting a telematics network, a Radio Frequency Identification (RFID) device, and/or one of various components constituting a computing system.

The memory device 150 may be a nonvolatile memory device that retains data stored therein even though power is not supplied. The memory device 150 may store data provided from the host 102 through a write operation, and provide data stored therein to the host 102 through a read operation. The memory device 150 may include a plurality of memory blocks 152, 154, 156 . . . , each of which may include a plurality of pages. Each of the pages may include a plurality of memory cells coupled to a word line. In an embodiment, the memory device 150 may be a flash memory. The flash memory may have a 3-dimensional (3D) stack structure.

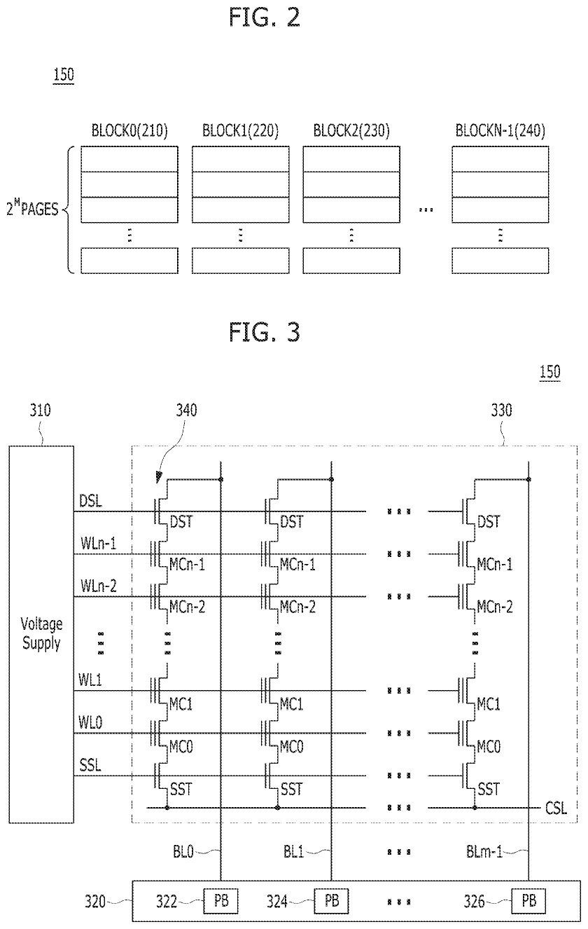

Since the structure of the memory device 150 including its 3D stack structure is described in detail with reference to FIGS. 2 to 4, further description of these elements and features are omitted here.

The controller 130 may control the memory device 150 in response to a request from the host 102. For example, the controller 130 may provide data read from the memory device 150 to the host 102, and store data provided from the host 102 into the memory device 150. For this operation, the controller 130 may control read, write, program and erase operations of the memory device 150.

The controller 130 may include a host interface (I/F) 132, a processor 134, an error correction code (ECC) component 138, a Power Management Unit (PMU) 140, a memory I/F 142 such as a NAND flash controller (NFC), and a memory 144, all operatively coupled via an internal bus.

The host interface 132 may be configured to process a command and data of the host 102, and may communicate with the host 102 through one or more of various interface protocols such as universal serial bus (USB), multi-media card (MMC), peripheral component interconnect-express (PCI-e or PCIe), small computer system interface (SCSI), serial-attached SCSI (SAS), serial advanced technology attachment (SATA), parallel advanced technology attachment (PATA), enhanced small disk interface (ESDI) and integrated drive electronics (IDE).

The ECC component 138 may detect and correct an error contained in the data read from the memory device 150. In other words, the ECC component 138 may perform an error correction decoding process to the read data using an ECC code used during an ECC encoding process. According to a result of the error correction decoding process, the ECC component 138 may output a signal, for example, an error correction success/fail signal. When the number of error bits is more than a threshold value of correctable error bits, the ECC component 138 may not correct the error bits, and may output an error correction fail signal.

The ECC component 138 may perform error correction through a coded modulation such as Low Density Parity Check (LDPC) code, Bose-Chaudhri-Hocquenghem (BCH) code, turbo code, Reed-Solomon code, convolution code, Recursive Systematic Code (RSC), Trellis-Coded Modulation (TCM) and Block coded modulation (BCM). However, the ECC component 138 is not limited to any specific technique or structure. As such, the ECC component 138 may include any and all circuits, modules, systems or devices for suitable error correction.

The PMU 140 may provide and manage power of the controller 130.

The memory I/F 142 may serve as a memory/storage interface for interfacing the controller 130 and the memory device 150 such that the controller 130 controls the memory device 150 in response to a request from the host 102. When the memory device 150 is a flash memory or specifically a NAND flash memory, the memory I/F 142 may generate a control signal for the memory device 150 and process data to be provided to the memory device 150 under the control of the processor 134. The memory I/F 142 may work as an interface (e.g., a NAND flash interface) for processing a command and data between the controller 130 and the memory device 150. Specifically, the memory I/F 142 may support data transfer between the controller 130 and the memory device 150.

The memory 144 may serve as a working memory of the memory system 110 and the controller 130, and store data for driving the memory system 110 and the controller 130. The controller 130 may control the memory device 150 to perform read, write, program and erase operations in response to a request from the host 102. The controller 130 may provide data read from the memory device 150 to the host 102, may store data provided from the host 102 into the memory device 150. The memory 144 may store data required for the controller 130 and the memory device 150 to perform these operations.

The memory 144 may be embodied by a volatile memory. For example, the memory 144 may be embodied by static random access memory (SRAM) or dynamic random access memory (DRAM). The memory 144 may be disposed within or externally to the controller 130. FIG. 1 exemplifies the memory 144 disposed within the controller 130. In another embodiment, the memory 144 may be embodied by an external volatile memory having a memory interface transferring data between the memory 144 and the controller 130.

The processor 134 may control the overall operations of the memory system 110. The processor 134 may drive firmware to control the overall operations of the memory system 110. The firmware may be referred to as flash translation layer (FTL). Also, the processor 134 may be realized as a microprocessor or a central processing unit (CPU).

For example, the controller 130 may perform an operation requested by the host 102 in the memory device 150 through the processor 134. In other words, the controller 130 may perform a command operation corresponding to a command received from the host 102, or other source. The controller 130 may perform a foreground operation as the command operation corresponding to the command received from the host 102. For example, the controller 130 may perform a program operation corresponding to a write command, a read operation corresponding to a read command, an erase operation corresponding to an erase command, and a parameter set operation corresponding to a set parameter command or a set feature command.

Also, the controller 130 may perform a background operation onto the memory device 150 through the processor 134. The background operation performed onto the memory device 150 may include an operation of copying and processing data stored in some memory blocks among the memory blocks 152 to 156 of the memory device 150 into other memory blocks, e.g., a garbage collection (GC) operation, an operation of swapping between select memory blocks of the memory blocks 152 to 156 or data thereof, e.g., a wear-leveling (WL) operation, an operation of storing the map data stored in the controller 130 in the memory blocks 152 to 156, e.g., a map flush operation, or an operation of managing bad blocks of the memory device 150, e.g., a bad block management operation of detecting and processing bad blocks among the memory blocks 152 to 156.

A memory device of the memory system of FIG. 1 is described in detail with reference to FIGS. 2 to 4.

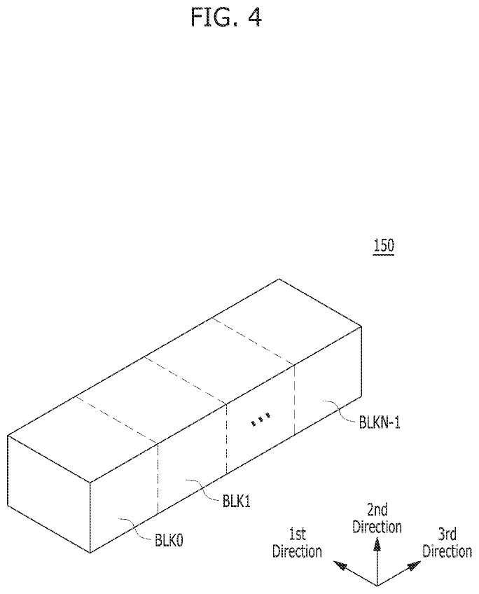

FIG. 2 is a schematic diagram illustrating the memory device 150, FIG. 3 is a circuit diagram illustrating an exemplary configuration of a memory cell array of a memory block in the memory device 150, and FIG. 4 is a schematic diagram illustrating an exemplary 3D structure of the memory device 150.

Referring to FIG. 2, the memory device 150 may include a plurality of memory blocks BLOCK0 to BLOCKN−1, e.g., BLOCK0 (210), BLOCK1 (220), BLOCK2 (230), and to BLOCKN−1 (240). Each of the memory blocks 210, 220, 230 and 240 may include a plurality of pages, for example 2^{M} pages, the number of which may vary according to circuit design. For example in some applications, each of the memory blocks may include M pages. Each of the pages may include a plurality of memory cells that are coupled to a plurality of word lines WL.

Also, the memory device 150 may include a plurality of memory blocks, which may include a single level cell (SLC) memory block storing 1-bit data and/or a multi-level cell (MLC) memory block storing 2-bit data. The SLC memory blocks may include a plurality of pages that are realized by memory cells storing one-bit data in one memory cell. The SLC memory blocks may have a quick data operation performance and high durability. On the other hand, the MLC memory blocks may include a plurality of pages that are realized by memory cells storing multi-bit data, e.g., data of two or more bits, in one memory cell. The MLC memory blocks may have a greater data storing space than the SLC memory blocks. In other words, the MLC memory blocks may be highly integrated. Particularly, the memory device 150 may include not only the MLC memory blocks, each of which includes a plurality of pages that are realized by memory cells capable of storing two-bit data in one memory cell, but also higher level MLC memory blocks including triple level cell (TLC) memory blocks each of which includes a plurality of pages that are realized by memory cells capable of storing three-bit data in one memory cell, quadruple level cell (QLC) memory blocks each of which includes a plurality of pages that are realized by memory cells capable of storing four-bit data in one memory cell, and/or higher multiple level cell memory blocks each of which includes a plurality of pages that are realized by memory cells capable of storing five or more-bit data in one memory cell, and so forth.

In accordance with an embodiment of the present invention, the memory device 150 is described as a non-volatile memory, such as a flash memory, e.g., a NAND flash memory. However, the memory device 150 may be realized as any of a Phase Change Random Access Memory (PCRAM), a Resistive Random Access Memory (RRAM or ReRAM), a Ferroelectric Random Access Memory (FRAM), a Spin Transfer Torque Magnetic Random Access Memory (STT-RAM or STT-MRAM).

The memory blocks 210, 220, 230 and 240 may store the data transferred from the host 102 through a program operation, and transfer data stored therein to the host 102 through a read operation.

Referring to FIG. 3, a memory block 330, which is representative of any of the plurality of memory blocks 152 to 156 in the memory device 150 of the memory system 110, may include a plurality of cell strings 340 coupled to a plurality of corresponding bit lines BL0 to BLm−1. The cell string 340 of each column may include one or more drain select transistors DST and one or more source select transistors SST. Between the drain and source select transistors DST and SST, a plurality of memory cells MC0 to MCn−1 may be coupled in series. In an embodiment, each of the memory cell transistors MC0 to MCn−1 may be embodied by an MLC capable of storing data information of a plurality of bits. Each of the cell strings 340 may be electrically coupled to a corresponding bit line among the plurality of bit lines BL0 to BLm−1. For example, as illustrated in FIG. 3, the first cell string is coupled to the first bit line BL0, and the last cell string is coupled to the last bit line BLm−1. For reference, in FIG. 3, ‘DSL’ denotes a drain select line, ‘SSL denotes a source select line, and ‘CSL’ denotes a common source line.

Although FIG. 3 illustrates NAND flash memory cells, the invention is not limited in this way. It is noted that the memory cells may be NOR flash memory cells, or hybrid flash memory cells including two or more types of memory cells combined therein. Also, it is noted that the memory device 150 may be a flash memory device including a conductive floating gate as a charge storage layer or a charge trap flash (CTF) memory device including an insulation layer as a charge storage layer.

The memory device 150 may further include a voltage supply 310 which provides word line voltages including a program voltage, a read voltage and a pass voltage to supply to the word lines according to an operation mode. The voltage generation operation of the voltage supply 310 may be controlled by a control circuit (not illustrated). Under the control of the control circuit, the voltage supply 310 may select one of the memory blocks (or sectors) of the memory cell array, select one of the word lines of the selected memory block, and provide the word line voltages to the selected word line and the unselected word lines as may be needed.

The memory device 150 may include a read and write (read/write) circuit 320 which is controlled by the control circuit. During a verification/normal read operation, the read/write circuit 320 may operate as a sense amplifier for reading data from the memory cell array. During a program operation, the read/write circuit 320 may operate as a write driver for driving bit lines according to data to be stored in the memory cell array. During a program operation, the read/write circuit 320 may receive from a buffer (not illustrated) data to be stored into the memory cell array, and drive bit lines according to the received data. The read/write circuit 320 may include a plurality of page buffers 322 to 326 respectively corresponding to columns (or bit lines) or column pairs (or bit line pairs), and each of the page buffers 322 to 326 may include a plurality of latches (not illustrated).

The memory device 150 may be embodied by a two-dimensional (2D) or three-dimensional (3D) memory device. Particularly, as illustrated in FIG. 4, the memory device 150 may be embodied by a nonvolatile memory device having a 3D stack structure. When the memory device 150 has a 3D structure, the memory device 150 may include a plurality of memory blocks BLOCK0 to BLOCKN−1, each realized in a 3D structure. FIG. 4 is a block diagram illustrating the memory blocks 152 to 156 of the memory device 150 shown in FIG. 1. Each of the memory blocks 152 to 156 may be realized in a 3D structure (or vertical structure). For example, the memory blocks 152 to 156 may be a 3D structure with dimensions extending in first to third directions, e.g., an x-axis direction, a y-axis direction, and a z-axis direction.

Each memory block 330 in the memory device 150 may include a plurality of NAND strings NS that extend in the second direction, and a plurality of NAND strings NS (not shown) that extend in the first direction and the third direction. Each of the NAND strings NS may be coupled to a bit line BL, at least one string select line SSL, at least one ground select line GSL (not shown), a plurality of word lines WL, at least one dummy word line DWL (not shown), and a common source line CSL, and each of the NAND strings NS may include a plurality of transistor structures TS (not shown).

In short, each memory block 330 may be coupled to a plurality of bit lines BL, a plurality of string select lines SSL, a plurality of ground select lines GSL, a plurality of word lines WL, a plurality of dummy word lines DWL, and a plurality of common source lines CSL, and each memory block 330 may include a plurality of NAND strings NS. Also, in each memory block 330, one bit line BL may be coupled to a plurality of NAND strings NS to realize a plurality of transistors in one NAND string NS. Also, a string select transistor SST of each NAND string NS may be coupled to a corresponding bit line BL, and a ground select transistor GST (not shown) of each NAND string NS may be coupled to a common source line CSL. Memory cells MC may be provided between the string select transistor SST and the ground select transistor GST of each NAND string NS. In other words, a plurality of memory cells may be realized in each memory block 330.

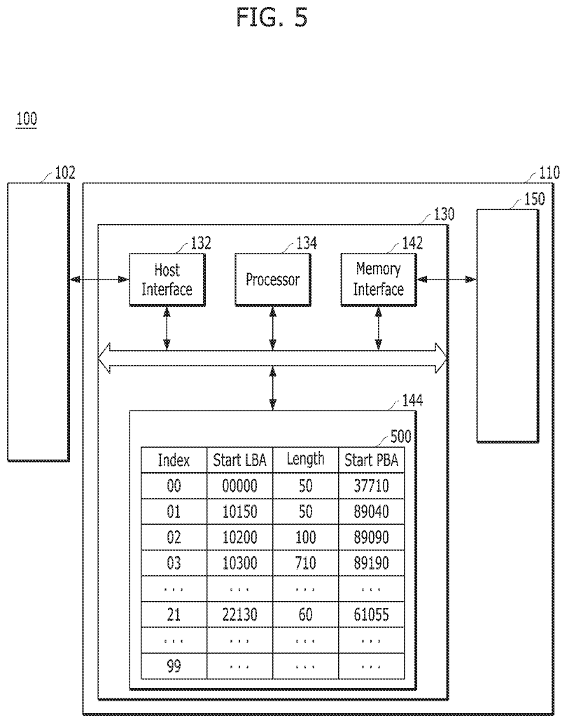

A data processing operation performed in the memory system in accordance with various embodiments of the present invention is described in detail with reference to FIGS. 5 to 7.

FIG. 5 schematically illustrates the structure of a data processing system 100 including a memory system 100 in accordance with an embodiment.

The memory system 110 in accordance with the present embodiment may include a controller 130 and a memory device 150. The controller 130 may include a host interface 132, a processor 134, a memory interface 142 and a memory 144. The respective components may correspond to those described with reference to FIG. 1. The memory 144 may include a map cache table 500.

In a nonvolatile memory device such as a flash memory which does not support an overwrite operation, the unit of program operation may not coincide with the unit of erase operation. In order to overcome such disadvantages, a flash translation layer (FTL) may perform an address mapping operation. Specifically, when receiving a logical address used in a file system from the host 102, the FTL may translate the logical address into a physical address to access the nonvolatile memory device. The FTL may include firmware which can be driven in the processor 134.

The controller 130 may use map data when accessing the memory device according to a request of the host. The map data may include data for address mapping between a logical address and a physical address. As the storage space of the memory device 150 is increased, the size of the map data may be increased.

Depending on the capacity of the memory 144, the entire map data may not be loaded to the memory 144. The processor 134 may store the entire map data in the memory device, and cache map data related to the recent access request into the memory.

The map cache table 500 in accordance with the present embodiment may cache sequential map data corresponding to the number of indexes. The sequential map data refer to map data which are obtained by caching only a start logical address, a physical logical address corresponding to the start logical address, and the number of sequential addresses, when physical addresses corresponding to sequential logical addresses are sequential to each other. Thus, the sequential map data can indicate physical addresses corresponding to all sequential logical addresses. When the sequential map data are cached, the storage space of the memory can be efficiently used.

Each of the indexes may include a start logical address (Start LBA), a sequential address number (Length) and a start physical address (Start PBA) as its fields. For example, the map cache table 500 of FIG. 5 may cache a total of 100 sequential map data.

The numbers of sequential address of the sequential map data may not be constant. When the sequential map data is cached in each index in the map cache table 500 in an unordered manner, significant time may be required for the processor 134 to check whether the sequential map data for the logical address are cached in the map cache table 500.

In accordance with an embodiment, the processor 134 may determine an index at which map data corresponding to each logical address of a memory device 150 can be cached, in order to cache sequential map data. In accordance with the present embodiment, the processor 134 may check whether the map data corresponding to the logical address are present, only for the corresponding index, in order to find the map data in the map cache table 500 for a read operation. Therefore, the read operation performance of the memory system can be improved.

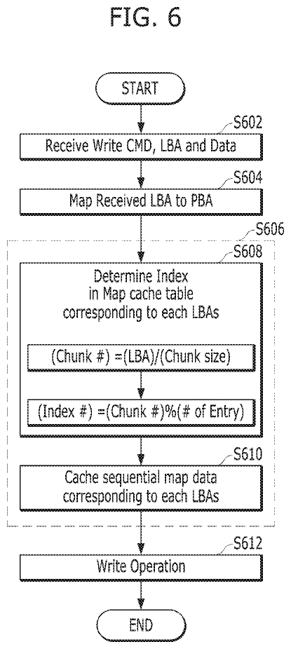

In accordance with the present embodiment, a specific logical address may correspond to one index. That is, logical addresses and indexes may have a many-to-one relationship. In the example of FIG. 5, a logical address ‘10150’ may correspond only to an index ‘01’, and a logical address ‘10222’ may correspond only to an index ‘02’. A specific method for mapping a logical address to an index of the map cache table 500 is described with reference to FIG. 6.

FIG. 6 is a flowchart illustrating an operation method of the memory system based on a write command in accordance with an embodiment of the present invention.

At step S602, the processor 134 may receive a write command, a logical address corresponding to the write command, and write data from the host 102 through the host interface 132. At this time, the processor 134 may receive one or more logical addresses. When the processor 134 receives a plurality of sequential logical addresses, the write command may be sequential write commands.

At step S604, the FTL may map the received logical address to a physical address to which data are to be written in the memory device 150, and generate map data corresponding to the mapping operation.

At step S606, the processor 134 may cache the generated map data in the map cache table 500. Step S606 may include sub steps S608 and S610.

As described above, a specific logical address may be cached only in an entry corresponding to one index. Therefore, at step S608, the processor 134 may determine an index corresponding to each of the received logical addresses.

In accordance with the present embodiment, all of the logical addresses of the memory device 150 may be divided into chunks. One chunk may include a set number of sequential logical addresses, which number may be predetermined. In this specification, the set number may be defined as a chunk size. For the entire memory device 150, the number of chunks may be equal to or larger than the number of indexes in the map cache table 500. A logical address included in a specific chunk may be cached only in an entry corresponding to one index.

For each of the received logical addresses, the processor 134 may perform the operation of dividing the corresponding logical address by the chunk size, thereby determining a chunk number indicating to which chunk the corresponding logical address belongs. By performing a modulo operation on the determined chunk number and the number of indexes in the map cache table 500, the processor 134 may determine an index corresponding to an entry in which the corresponding chunk can be cached. That is, such an operation of the processor 134 can determine in which entry each of the received logical addresses is to be cached.

At step S610, the processor 134 may cache sequential map data corresponding to each of the received logical addresses in the determined entry of the map cache table 500.

When the map data caching is completed at step S606, the processor 134 may perform a write operation in response to the received write command at step S612.

Referring to FIG. 5, the operation of step S606 is described as follows.

Suppose that the processor 134 receives logical addresses ‘10150’ to ‘10370’ with a write command at step S602, and physical addresses ‘89040’ to ‘89260’ are mapped to the corresponding logical addresses at step S604.

In the example of FIG. 5, the number of indexes in the map cache table 500 may be set to 100, and the chunk size may be set to 100. The total number of logical addresses of the memory device 150 may be set to 100,000, and the total number of chunks may be set to 1,000.

At step S608, the processor 134 may perform an operation of dividing the logical address ‘10150’ by the chunk size of, e.g., 100, and thus recognize that the logical address ‘10150’ belongs to the 101st chunk. The processor 134 may perform a modulo operation on the chunk number ‘101’ and the index number of 100, and determine that the logical address ‘10150’ belonging to the 101st chunk is cached at the index ‘01’.

Similarly, the logical addresses ‘10151’ to ‘10199’ may be cached at the index ‘01’. The logical addresses ‘10200’ to ‘10299’ may be cached at the index ‘02’, and the logical addresses ‘10300’ to ‘10370’ may be cached at the index ‘03’. That is, map data corresponding to the received logical addresses ‘10150’ to ‘10370’ may be divided and cached in three entries.

At step S610, the processor 134 may cache sequential map data corresponding to the logical addresses ‘10150’ to ‘10199’ in the entries corresponding to the index ‘01’. The start logical address, the start physical address and the number of sequential addresses, which are cached in the respective entries of the index ‘01’, may be ‘10150’, ‘89040’ and 50. Similarly, the start logical address, the start physical address and the number of sequential addresses, which are cached in the respective entries of the index ‘02’, may be ‘10200’, ‘89090’, and 100. The start logical address, the start physical address and the number of sequential addresses, which are cached in the respective entries of the index ‘03’, may be ‘10300’, ‘80190’ and 71.

The method that divides logical addresses in the memory device 150 into chunks and maps each of the chunks to one index has been described as a method for mapping a specific logical address to one index. However, the present invention is not limited thereto; Rather, the present invention encompasses any suitable method or algorithm may be used as long as a specific logical address can be mapped to only one index.

In accordance with the present embodiment, at step S806, the processor 134 may divide each of the received logical addresses by the entry size, thereby immediately mapping the corresponding logical address to one index. The entry size may indicate the total number of logical addresses which can correspond to one entry. In the example of FIG. 5, since the number of logical addresses in the memory device 150 is 100,000 and the number of indexes is 100, the entry size may be set to 1,000. Such an embodiment depicts the case in which the number of chunks is equal to the number of indexes in the map cache table 500.

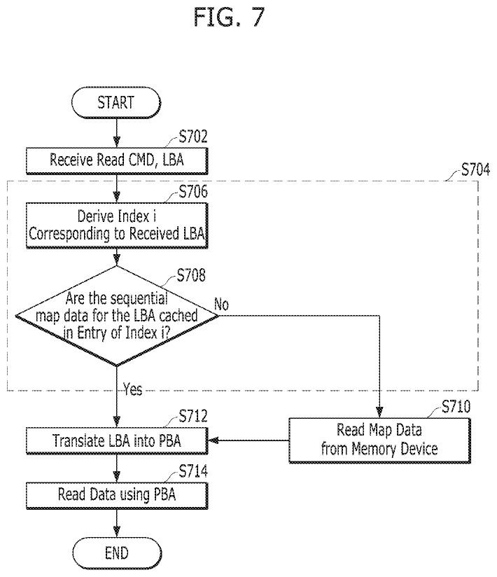

FIG. 7 is a flowchart illustrating a read operation process of the memory system 110 in accordance with the present embodiment.

At step S702, the processor 134 may receive a read command and a logical address corresponding to the read command from the host 102 through the host interface 132.

The processor 134 may check whether map data for the logical address are cached in the map cache table 500, at step S704. Step S704 may include sub steps S706 and S708.

At step S706, the processor 134 may derive an index corresponding to the received logical address. The same algorithm as that for mapping a specific logical address to only one index as described with reference to FIG. 6 may be used for deriving the index.

In the example described with reference to FIG. 5, when receiving a logical address ‘20345’, the processor 134 may divide the corresponding logical address by the chunk size of 100, and determine that the corresponding logical address belongs to the 203rd chunk. Furthermore, the processor 134 may perform a modulo operation on the chunk number ‘203’ and the entry number of 100, and determine that the corresponding logical address corresponds to the index ‘03’.

At step S708, the processor 134 may determine whether sequential map data corresponding to the logical address are cached in an entry corresponding to the derived index. In the example of FIG. 5, only sequential map data corresponding to the logical addresses ‘10300’ to ‘10370’ may be cached at the index ‘03’, and sequential map data corresponding to the logical address ‘20345’ may not be cached at the index ‘03’.

When the sequential map data corresponding to the logical address are not cached in the entry (“No” at step S708), the processor 134 may read map data corresponding to the logical address from the memory device at step S710.

When the sequential map data corresponding to the logical address are cached (“Yes” at step S708), the processor 134 may perform step S712.

At step S712, the processor 134 may translate the logical address into a physical address by referring to the map data.

At step S714, the processor 134 may read data by accessing the memory device using the physical address.

In accordance with embodiments of the present invention, when map data are cached, only one index of the map cache table may be mapped to one logical address. Therefore, when the map data are needed, the processor 134 may check only one entry in which a received logical address may be cached, for the corresponding logical address, thereby determining whether the map data are cached in the map cache table 700. Thus, in accordance with the embodiments of the present invention, the read performance of the memory system 110 can be improved.

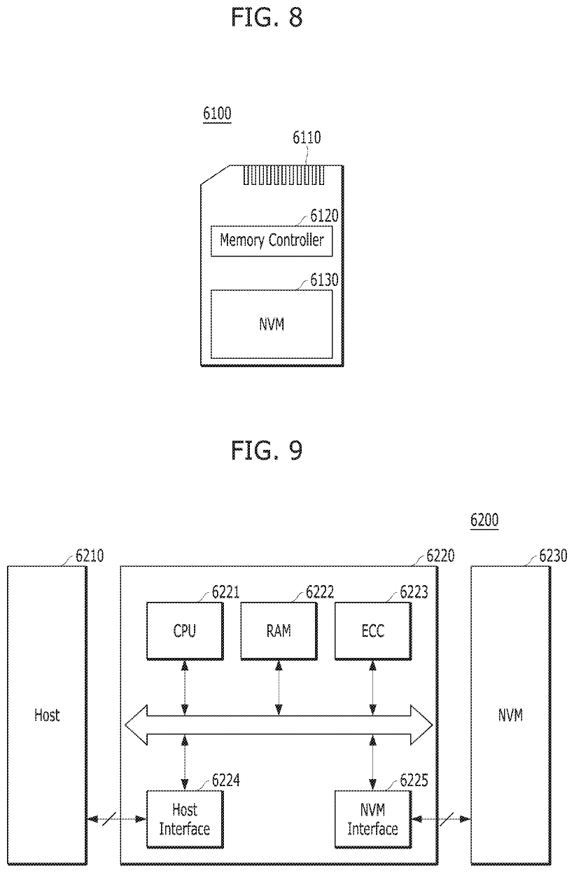

FIGS. 8 to 16 are diagrams schematically illustrating application examples of the data processing system of FIGS. 1 to 7 according to various embodiments.

FIG. 8 is a diagram schematically illustrating the data processing system including the controller in accordance with an embodiment. FIG. 8 schematically illustrates a memory card system 6100 to which the controller is applied.

Referring to FIG. 8, the memory card system 6100 may include a memory controller 6120, a memory device 6130 and a connector 6110.

More specifically, the memory controller 6120 may be connected to the memory device 6130 embodied by a nonvolatile memory (NVM), and configured to access the memory device 6130. For example, the memory controller 6120 may be configured to control read, write, erase and background operations of the memory device 6130. The memory controller 6120 may be configured to provide an interface between the memory device 6130 and a host (not shown), and drive firmware for controlling the memory device 6130. That is, the memory controller 6120 may correspond to the controller 130 of the memory system 110 described with reference to FIG. 1, and the memory device 6130 may correspond to the memory device 150 of the memory system 110 described with reference to FIG. 1.

Thus, as shown in FIG. 1, the memory controller 6120 may include a random access memory (RAM), a processor, a host interface, a memory interface and an error correction component.

The memory controller 6120 may communicate with an external device, for example the host 102 of FIG. 1, through the connector 6110. For example, as described with reference to FIG. 1, the memory controller 6120 may be configured to communicate with an external device through one or more of various communication protocols such as universal serial bus (USB), multimedia card (MMC), embedded MMC (eMMC), peripheral component interconnection (PCI), PCI express (PCIe), Advanced Technology Attachment (ATA), Serial-ATA, Parallel-ATA, small computer system interface (SCSI), enhanced small disk interface (EDSI), Integrated Drive Electronics (IDE), Firewire, universal flash storage (UFS), wireless fidelity (Wi-Fi or WiFi) and Bluetooth. Thus, the memory system and the data processing system may be applied to wired and/or wireless electronic devices, particularly mobile electronic devices.

The memory device 6130 may be implemented by any of various nonvolatile memory devices such as an erasable and programmable ROM (EPROM), an electrically erasable and programmable ROM (EEPROM), a NAND flash memory, a NOR flash memory, a phase-change RAM (PRAM), a resistive RAM (ReRAM), a ferroelectric RAM (FRAM) and a spin torque transfer magnetic RAM (STT-RAM).

The memory controller 6120 and the memory device 6130 may be integrated into a single semiconductor device. For example, the memory controller 6120 and the memory device 6130 may be integrated to form a solid-state driver (SSD). Alternatively, the memory controller 6120 and the memory device 6130 may be integrated form a memory card such as a PC card (e.g., Personal Computer Memory Card International Association (PCMCIA)), a compact flash (CF) card, a smart media card (e.g., SM and SMC), a memory stick, a multimedia card (e.g., MMC, RS-MMC, MMCmicro and eMMC), an secured digital (SD) card (e.g., SD, miniSD, microSD and SDHC) and/or a universal flash storage (UFS).

FIG. 9 is a diagram schematically illustrating another example of a data processing system 6200 including the controller in accordance with an embodiment.

Referring to FIG. 9, the data processing system 6200 may include a memory device 6230 having one or more nonvolatile memories (NVMs) and a memory controller 6220 for controlling the memory device 6230. The data processing system 6200 may serve as a storage medium such as a memory card (CF, SD, micro-SD or the like) or USB device, as described with reference to FIG. 1. The memory device 6230 may correspond to the memory device 150 in the memory system 110 illustrated in FIG. 1, and the memory controller 6220 may correspond to the controller 130 in the memory system 110 illustrated in FIG. 1.

The memory controller 6220 may control a read, write or erase operation on the memory device 6230 in response to a request of the host 6210, and the memory controller 6220 may include one or more central processing units (CPUs) 6221, a buffer memory such as a random access memory (RAM) 6222, an error correction code (ECC) circuit 6223, a host interface 6224 and a memory interface such as an NVM interface 6225.

The CPU 6221 may control overall operations on the memory device 6230, for example, read, write, file system management and bad page management operations. The RAM 6222 may be operated according to control of the CPU 6221, and used as a work memory, buffer memory or cache memory. When the RAM 6222 is used as a work memory, data processed by the CPU 6221 may be temporarily stored in the RAM 6222. When the RAM 6222 is used as a buffer memory, the RAM 6222 may be used for buffering data transmitted to the memory device 6230 from the host 6210 or transmitted to the host 6210 from the memory device 6230. When the RAM 6222 is used as a cache memory, the RAM 6222 may assist the memory device 6230 to operate at high speed.

The ECC circuit 6223 may correspond to the ECC component 138 of the controller 130 illustrated in FIG. 1. As described with reference to FIG. 1, the ECC circuit 6223 may generate an error correction code (ECC) for correcting a fail bit or error bit of data provided from the memory device 6230. The ECC circuit 6223 may perform error correction encoding on data provided to the memory device 6230, thereby forming data with a parity bit. The parity bit may be stored in the memory device 6230. The ECC circuit 6223 may perform error correction decoding on data outputted from the memory device 6230. The ECC circuit 6223 may correct an error using the parity bit. For example, as described with reference to FIG. 1, the ECC circuit 6223 may correct an error using Low Density Parity Check (LDPC) code, Bose-Chaudhri-Hocquenghem (BCH) code, turbo code, Reed-Solomon code, convolution code, Recursive Systematic Code (RSC) or coded modulation such as Trellis-Coded Modulation (TCM) or Block coded modulation (BCM).

The memory controller 6220 may exchange data with the host 6210 through the host interface 6224, and exchange data with the memory device 6230 through the NVM interface 6225. The host interface 6224 may be connected to the host 6210 through a parallel advanced technology attachment (PATA) bus, serial advanced technology attachment (SATA) bus, small computer system interface (SCSI), universal serial bus (USB), peripheral component interconnect-express (PCIe) or NAND interface. The memory controller 6220 may have a wireless communication function with a mobile communication protocol such as wireless fidelity (WiFi) or Long Term Evolution (LTE). The memory controller 6220 may be connected to an external device, for example, the host 6210 or another external device, and then exchange data with the external device. In particular, as the memory controller 6220 is configured to communicate with the external device through one or more of various communication protocols, the memory system and the data processing system may be applied to wired and/or wireless electronic devices, particularly a mobile electronic device.

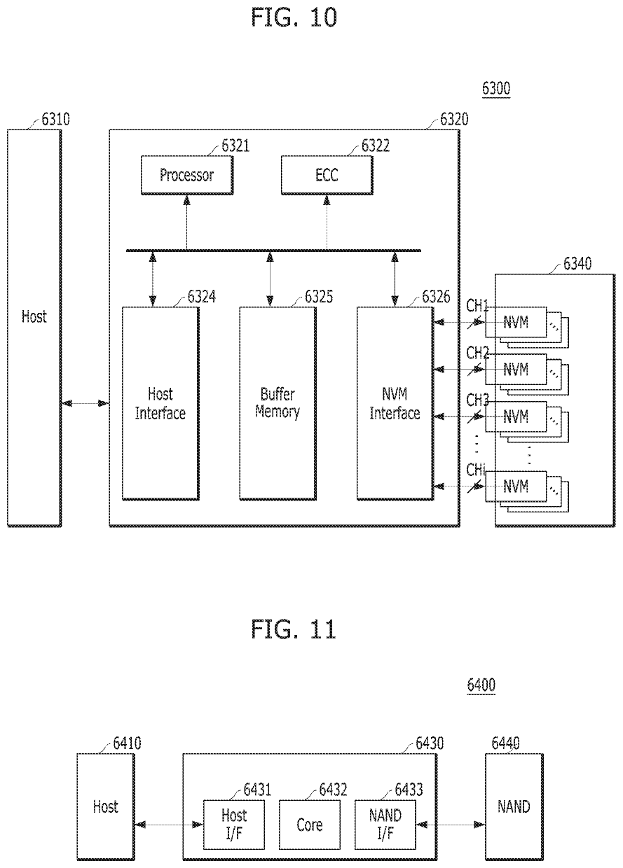

FIG. 10 is a diagram schematically illustrating another example of the data processing system including the controller in accordance with an embodiment. FIG. 10 schematically illustrates a solid state drive (SSD) 6300 to which the memory system may be applied.

Referring to FIG. 10, the SSD 6300 may include a controller 6320 and a memory device 6340 including a plurality of nonvolatile memories (NVMs). The controller 6320 may correspond to the controller 130 in the memory system 110 of FIG. 1, and the memory device 6340 may correspond to the memory device 150 in the memory system of FIG. 1.

More specifically, the controller 6320 may be connected to the memory device 6340 through a plurality of channels CH1 to CHi. The controller 6320 may include one or more processors 6321, an error correction code (ECC) circuit 6322, a host interface 6324, a buffer memory 6325 and a memory interface, for example, a nonvolatile memory interface 6326.

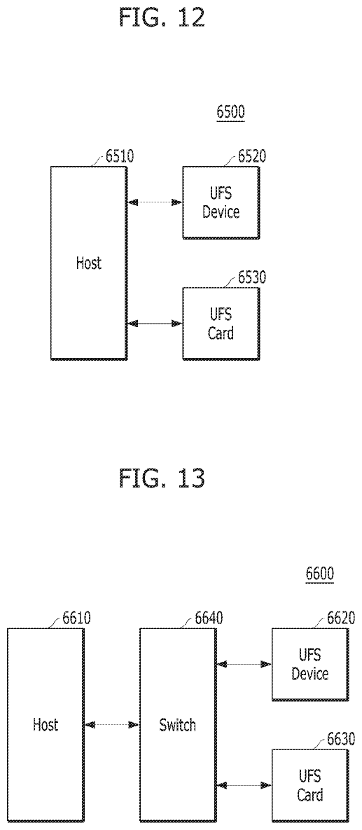

The buffer memory 6325 may temporarily store data provided from the host 6310 or data provided from a plurality of flash memories NVM included in the memory device 6340, or temporarily store meta data of the plurality of flash memories NVM, for example, map data including a mapping table. The buffer memory 6325 may be embodied by volatile memories such as dynamic random access memory (DRAM), synchronous DRAM (SDRAM), double data rate (DDR) SDRAM, low power DDR (LPDDR) SDRAM and graphics RAM (GRAM) or nonvolatile memories such as ferroelectric RAM (FRAM), resistive RAM (RRAM or ReRAM), spin-transfer torque magnetic RAM (STT-MRAM) and phase-change RAM (PRAM). By way of example, FIG. 12 illustrates that the buffer memory 6325 is disposed in the controller 6320. However, the buffer memory 6325 may be disposed externally to the controller 6320.

The ECC circuit 6322 may calculate an error correction code (ECC) value of data to be programmed to the memory device 6340 during a program operation, perform an error correction operation on data read from the memory device 6340 based on the ECC value during a read operation, and perform an error correction operation on data recovered from the memory device 6340 during a failed data recovery operation.

The host interface 6324 may provide an interface function with an external device, for example, the host 6310, and the nonvolatile memory interface 6326 may provide an interface function with the memory device 6340 connected through the plurality of channels.

Furthermore, a plurality of SSDs 6300 to which the memory system 110 of FIG. 1 is applied may embody a data processing system, for example, a redundant array of independent disks (RAID) system. The RAID system may include the plurality of SSDs 6300 and a RAID controller for controlling the plurality of SSDs 6300. When the RAID controller performs a program operation in response to a write command provided from the host 6310, the RAID controller may select one or more memory systems or SSDs 6300 according to a plurality of RAID levels, that is, RAID level information of the write command provided from the host 6310 in the SSDs 6300, and output data corresponding to the write command to the selected SSDs 6300. Furthermore, when the RAID controller performs a read command in response to a read command provided from the host 6310, the RAID controller may select one or more memory systems or SSDs 6300 according to a plurality of RAID levels, that is, RAID level information of the read command provided from the host 6310 in the SSDs 6300, and provide data read from the selected SSDs 6300 to the host 6310.

FIG. 11 is a diagram schematically illustrating another example of the data processing system including the controller in accordance with an embodiment. FIG. 11 schematically illustrates an embedded Multi-Media Card (eMMC) 6400 to which the memory system may be applied.

Referring to FIG. 11, the eMMC 6400 may include a controller 6430 and a memory device 6440 embodied by one or more NAND flash memories. The controller 6430 may correspond to the controller 130 in the memory system 110 of FIG. 1, and the memory device 6440 may correspond to the memory device 150 in the memory system 110 of FIG. 1.

More specifically, the controller 6430 may be connected to the memory device 6440 through a plurality of channels. The controller 6430 may include one or more cores 6432, a host interface (I/F) 6431 and a memory interface, for example, a NAND interface (I/F) 6433.

The core 6432 may control overall operations of the eMMC 6400, the host interface 6431 may provide an interface function between the controller 6430 and the host 6410, and the NAND interface 6433 may provide an interface function between the memory device 6440 and the controller 6430. For example, the host interface 6431 may serve as a parallel interface, for example, MMC interface as described with reference to FIG. 1. Furthermore, the host interface 6431 may serve as a serial interface, for example, Ultra High Speed (UHS)-I and/or UHS-II interface.

FIGS. 12 to 15 are diagrams schematically illustrating other examples of the data processing system including the memory system in accordance with one or more embodiments. FIGS. 12 to 15 schematically illustrate universal flash storage (UFS) systems to which the memory system may be applied.

Referring to FIGS. 12 to 15, the UFS systems 6500, 6600, 6700 and 6800 may include hosts 6510, 6610, 6710 and 6810, UFS devices 6520, 6620, 6720 and 6820 and UFS cards 6530, 6630, 6730 and 6830, respectively. The hosts 6510, 6610, 6710 and 6810 may serve as application processors of wired and/or wireless electronic devices or particularly mobile electronic devices, the UFS devices 6520, 6620, 6720 and 6820 may serve as embedded UFS devices. The UFS cards 6530, 6630, 6730 and 6830 may serve as external embedded UFS devices or removable UFS cards.

The hosts 6510, 6610, 6710 and 6810, the UFS devices 6520, 6620, 6720 and 6820 and the UFS cards 6530, 6630, 6730 and 6830 in the respective UFS systems 6500, 6600, 6700 and 6800 may communicate with external devices, for example, wired and/or wireless electronic devices, particularly mobile electronic devices, through UFS protocols. The UFS devices 6520, 6620, 6720 and 6820 and the UFS cards 6530, 6630, 6730 and 6830 may be embodied by the memory system 110 illustrated in FIG. 1. For example, in the UFS systems 6500, 6600, 6700 and 6800, the UFS devices 6520, 6620, 6720 and 6820 may be embodied in the form of the data processing system 6200, the SSD 6300 or the eMMC 6400 described with reference to FIGS. 9 to 11, and the UFS cards 6530, 6630, 6730 and 6830 may be embodied in the form of the memory card system 6100 described with reference to FIG. 8.

Furthermore, in the UFS systems 6500, 6600, 6700 and 6800, the hosts 6510, 6610, 6710 and 6810, the UFS devices 6520, 6620, 6720 and 6820 and the UFS cards 6530, 6630, 6730 and 6830 may communicate with each other through an UFS interface, for example, MIPI M-PHY and MIPI UniPro (Unified Protocol) in MIPI (Mobile Industry Processor Interface). Furthermore, the UFS devices 6520, 6620, 6720 and 6820 and the UFS cards 6530, 6630, 6730 and 6830 may communicate with each other through any of various protocols other than the UFS protocol, for example, universal storage bus (USB) Flash Drives (UFDs), multi-media card (MMC), secure digital (SD), mini-SD, and micro-SD.

In the UFS system 6500 illustrated in FIG. 12, each of the host 6510, the UFS device 6520 and the UFS card 6530 may include UniPro. The host 6510 may perform a switching operation in order to communicate with the UFS device 6520 and the UFS card 6530. In particular, the host 6510 may communicate with the UFS device 6520 or the UFS card 6530 through link layer switching, for example, L3 switching at the UniPro. The UFS device 6520 and the UFS card 6530 may communicate with each other through link layer switching at the UniPro of the host 6510. In FIG. 12, the configuration in which one UFS device 6520 and one UFS card 6530 are connected to the host 6510 is illustrated by way of example. However, a plurality of UFS devices and UFS cards may be connected in parallel or in the form of a star to the host 6510, and a plurality of UFS cards may be connected in parallel or in the form of a star to the UFS device 6520 or connected in series or in the form of a chain to the UFS device 6520.

In the UFS system 6600 illustrated in FIG. 13, each of the host 6610, the UFS device 6620 and the UFS card 6630 may include UniPro, and the host 6610 may communicate with the UFS device 6620 or the UFS card 6630 through a switching module 6640 performing a switching operation, for example, through the switching module 6640 which performs link layer switching at the UniPro, for example, L3 switching. The UFS device 6620 and the UFS card 6630 may communicate with each other through link layer switching of the switching module 6640 at UniPro. In FIG. 13, the configuration in which one UFS device 6620 and one UFS card 6630 are connected to the switching module 6640 is illustrated by way of example. However, a plurality of UFS devices and UFS cards may be connected in parallel or in the form of a star to the switching module 6640, and a plurality of UFS cards may be connected in series or in the form of a chain to the UFS device 6620.

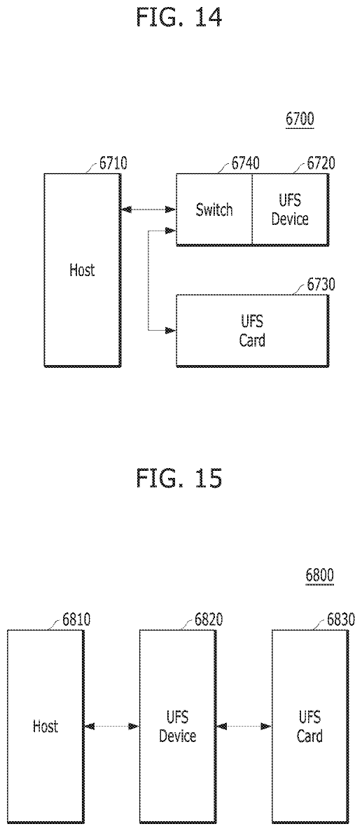

In the UFS system 6700 illustrated in FIG. 14, each of the host 6710, the UFS device 6720 and the UFS card 6730 may include UniPro. The host 6710 may communicate with the UFS device 6720 or the UFS card 6730 through a switching module 6740 performing a switching operation, for example, through the switching module 6740 which performs link layer switching at the UniPro, for example, L3 switching. The UFS device 6720 and the UFS card 6730 may communicate with each other through link layer switching of the switching module 6740 at the UniPro, and the switching module 6740 may be integrated as one module with the UFS device 6720 inside or outside the UFS device 6720. In FIG. 14, the configuration in which one UFS device 6720 and one UFS card 6730 are connected to the switching module 6740 is illustrated by way of example. However, a plurality of modules each including the switching module 6740 and the UFS device 6720 may be connected in parallel or in the form of a star to the host 6710 or connected in series or in the form of a chain to each other. Furthermore, a plurality of UFS cards may be connected in parallel or in the form of a star to the UFS device 6720.

In the UFS system 6800 illustrated in FIG. 15, each of the host 6810, the UFS device 6820 and the UFS card 6830 may include M-PHY and UniPro. The UFS device 6820 may perform a switching operation in order to communicate with the host 6810 and the UFS card 6830. In particular, the UFS device 6820 may communicate with the host 6810 or the UFS card 6830 through a switching operation between the M-PHY and UniPro module for communication with the host 6810 and the M-PHY and UniPro module for communication with the UFS card 6830, for example, through a target Identifier (ID) switching operation. The host 6810 and the UFS card 6830 may communicate with each other through target ID switching between the M-PHY and UniPro modules of the UFS device 6820. In FIG. 15, the configuration in which one UFS device 6820 is connected to the host 6810 and one UFS card 6830 is connected to the UFS device 6820 is illustrated by way of example. However, a plurality of UFS devices may be connected in parallel or in the form of a star to the host 6810, or connected in series or in the form of a chain to the host 6810, and a plurality of UFS cards may be connected in parallel or in the form of a star to the UFS device 6820, or connected in series or in the form of a chain to the UFS device 6820.

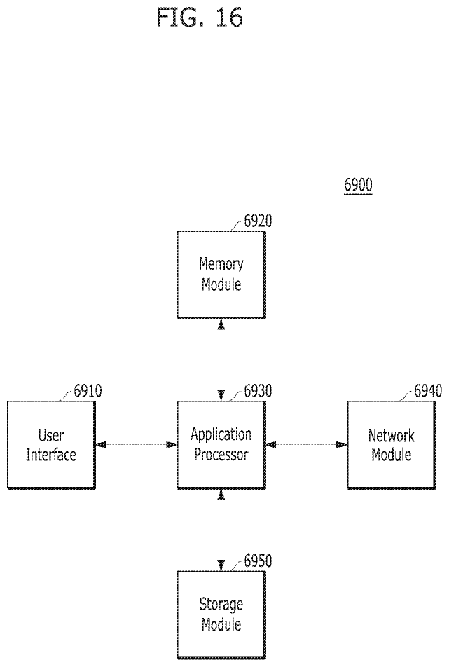

FIG. 16 is a diagram schematically illustrating another example of the data processing system including the memory system in accordance with an embodiment. FIG. 16 is a diagram schematically illustrating a user system 6900 to which the memory system may be applied.

Referring to FIG. 16, the user system 6900 may include a user interface 6910, a memory module 6920, an application processor 6930, a network module 6940, and a storage module 6950.

More specifically, the application processor 6930 may drive components included in the user system 6900, for example, an operating system (OS), and include controllers, interfaces and a graphic engine which control the components included in the user system 6900. The application processor 6930 may be provided as System-on-Chip (SoC).

The memory module 6920 may be used as a main memory, work memory, buffer memory or cache memory of the user system 6900. The memory module 6920 may include a volatile random access memory (RAM) such as a dynamic RAM (DRAM), a synchronous DRAM (SDRAM), a double data rate (DDR) SDRAM, DDR2 SDRAM, DDR3 SDRAM, LPDDR SDARM, LPDDR3 SDRAM or LPDDR3 SDRAM or a nonvolatile RAM such as a phase-change RAM (PRAM), a resistive RAM (ReRAM), a magneto-resistive RAM (MRAM) or a ferroelectric RAM (FRAM). For example, the application processor 6930 and the memory module 6920 may be packaged and mounted, based on Package on Package (PoP).

The network module 6940 may communicate with external devices. For example, the network module 6940 may not only support wired communication, but also support various wireless communication protocols such as code division multiple access (CDMA), global system for mobile communication (GSM), wideband CDMA (WCDMA), CDMA-2000, time division multiple access (TDMA), long term evolution (LTE), worldwide interoperability for microwave access (Wimax), wireless local area network (WLAN), ultra-wideband (UWB), Bluetooth, wireless display (WI-DI), thereby communicating with wired/wireless electronic devices or particularly mobile electronic devices. Therefore, the memory system and the data processing system can be applied to wired/wireless electronic devices. The network module 6940 may be included in the application processor 6930.

The storage module 6950 may store data, for example, data received from the application processor 6930, and then may transmit the stored data to the application processor 6930. The storage module 6950 may be embodied by a nonvolatile semiconductor memory device such as a phase-change RAM (PRAM), a magnetic RAM (MRAM), a resistive RAM (ReRAM), a NAND flash, NOR flash and 3D NAND flash, and provided as a removable storage medium such as a memory card or external drive of the user system 6900. The storage module 6950 may correspond to the memory system 110 described with reference to FIG. 1. Furthermore, the storage module 6950 may be embodied as an SSD, eMMC and UFS as described above with reference to FIGS. 10 to 15.

The user interface 6910 may include interfaces for inputting data or commands to the application processor 6930 or outputting data to an external device. For example, the user interface 6910 may include user input interfaces such as a keyboard, a keypad, a button, a touch panel, a touch screen, a touch pad, a touch ball, a camera, a microphone, a gyroscope sensor, a vibration sensor and a piezoelectric element, and user output interfaces such as a liquid crystal display (LCD), an organic light emitting diode (OLED) display device, an active matrix OLED (AMOLED) display device, an LED, a speaker and a motor.

Furthermore, when the memory system 110 of FIG. 1 is applied to a mobile electronic device of the user system 6900, the application processor 6930 may control overall operations of the mobile electronic device, and the network module 6940 may serve as a communication module for controlling wired and/or wireless communication with an external device. The user interface 6910 may display data processed by the processor 6930 on a display/touch module of the mobile electronic device, or support a function of receiving data from the touch panel.

In accordance with embodiments of the present invention, a controller capable of improving read performance of memory system by reducing the map data search time, and an operation method thereof, are provided.

Although various embodiments have been illustrated and described, it will be apparent to those skilled in the art in light of the present disclosure that various changes and modifications may be made without departing from the spirit and scope of the invention as defined in the following claims.

What is claimed is:

1. An operation method of a controller which controls a memory device, the operation method comprising:
deriving an index corresponding to a logical address included in a read command based on the logical address and the number of indexes in a map cache table; and
controlling the memory device to perform an operation corresponding to the read command by accessing a physical address corresponding to the logical address, depending on whether map data corresponding to the logical address are present in an entry corresponding to the derived index in the map cache table.

2. The operation method of claim 1, wherein the deriving of the index corresponding to the logical address comprises:
deriving a chunk number corresponding to the logical address by dividing the logical address by a chunk size; and
deriving the index corresponding to the logical address by performing a modulo operation on the derived chunk number and the number of indexes.

3. The operation method of claim 1, wherein the deriving of the index corresponding to the logical address comprises deriving the index corresponding to the logical address by dividing the logical address by an entry size,
wherein the entry size is derived by dividing the total number of logical addresses of the memory device by the total number of entries of the map cache table.

4. The operation method of claim 1, further comprising caching map data in the map cache table based on the logical address and the number of indexes in the map cache table.

5. The operation method of claim 4, wherein the caching of the map data in the map cache table comprises:
mapping each of logical addresses included in a write command to a physical address;
determining an index corresponding to each of the logical addresses in the write command based on the corresponding logical address and the number of indexes in the map cache table; and
caching map data corresponding to the performed mapping in entries corresponding to the determined indexes.

6. The operation method of claim 5, wherein the determining of the index corresponding to each of the logical addresses in the write command comprises:
determining a chunk number corresponding to each of the logical addresses in the write command by dividing the corresponding logical address by a chunk size; and
determining an index corresponding to each of the logical addresses in the write command by performing a modulo operation on each determined chunk number and the number of indexes.

7. The operation method of claim 6, wherein the caching of the map data corresponding to the performed mapping in the entries corresponding to the indexes comprises, for each entry, caching a start logical address, a corresponding start physical address and the number of sequential addresses in the entry corresponding to the index.

8. An operation method of a controller which controls a memory device, the operation method comprising:
mapping a logical address included in a write command to a physical address of the memory device;
determining an index corresponding to the logical address based on the logical address and the number of indexes in a map cache table;
caching map data corresponding to the performed mapping in an entry corresponding to the index; and
controlling the memory device to perform a write operation corresponding to the write command.

9. The operation method of claim 8, wherein the determining of the index corresponding to the logical address comprises:
deriving a chunk number corresponding to the logical address by dividing the logical address by a chunk size; and
determining the index corresponding to the logical address by performing a modulo operation on the derived chunk number and the number of indexes,
wherein the caching of the map data corresponding to the performed mapping in the entry corresponding to the index comprises caching a start logical address, a corresponding start physical address and the number of sequential addresses in the entry corresponding to the index.

10. The operation method of claim 8, further comprising:
deriving an index corresponding to a logical address included in a read command based on the corresponding logical address and the number of indexes in the map cache table; and
controlling the memory device to perform an operation corresponding to the read command by accessing a physical address corresponding to the logical address in the read command, depending on whether map data corresponding to the logical address are present in an entry corresponding to the derived index in the map cache table.

11. A controller for controlling a memory device, comprising:
a map cache table suitable for caching map data based on a logical address and the number of indexes; and
a processor suitable for deriving an index corresponding to a logical address included in a read command based on the logical address and the number of indexes in the map cache table, and controlling the memory device to perform an operation corresponding to the read command by accessing a physical address corresponding to the logical address, depending on whether map data corresponding to the logical address is present in an entry corresponding to the derived index.

12. The controller of claim 11, wherein the processor derives a chunk number corresponding to the logical address by dividing the logical address included in the read command by a chunk size, and derives the index corresponding to the logical address by performing a modulo operation on the derived chunk number and the number of indexes.

13. The controller of claim 11, wherein the processor derives the index corresponding to the logical address by dividing the logical address included in the read command by an entry size,
wherein the entry size is derived by dividing the total number of logical addresses of the memory device by the total number of entries of the map cache table.

14. The controller of claim 11, wherein the processor maps each of logical addresses included in a write command to a physical address, determines an index corresponding to each of the logical addresses in the write command based on the corresponding logical address and the number of indexes in the map cache table, and caches map data corresponding to the performed mapping in the map cache table by caching the map data in entries corresponding to the derived indexes.

15. The controller of claim 14, wherein the processor determines a chunk number corresponding to each of the logical addresses in the write command by dividing the corresponding logical address by a chunk size, and determines the index corresponding to the logical address by performing a modulo operation on the determined chunk number and the number of indexes.

16. The controller of claim 15, wherein the map cache table comprises, as fields, a start logical address, a corresponding start physical address and the number of sequential addresses.

17. A controller for controlling a memory device, comprising:
a map cache table; and
a processor suitable for mapping a logical address included in a write command to a physical address of the memory device, determining an index corresponding to the logical address based on the logical address and the number of indexes in the map cache table, caching map data corresponding to the performed mapping in an entry corresponding to the index in the map cache table, and controlling the memory device to perform a write operation corresponding to the write command.

18. The controller of claim 17, wherein the processor derives a chunk number corresponding to the logical address by dividing the logical address by a chunk size, and determines the index corresponding to the logical address by performing a modulo operation on the derived chunk number and the number of indexes.

19. The controller of claim 18, wherein the map cache table comprises, as fields, a start logical address, a corresponding start physical address and the number of sequential addresses.

20. The controller of claim 19, wherein the processor derives an index corresponding to a logical address included in a read command based on the corresponding logical address and the number of indexes in the map cache table, and controls the memory device to perform an operation corresponding to the read command by accessing a physical address corresponding to the logical address in the read command, depending on whether map data corresponding to the logical address is present in an entry corresponding to the derived index in the map cache table.

21. A memory system comprising:
a memory device in which there are a plurality of logical addresses divided into chunks of equal size, each of which includes a distinct set of sequential logical addresses among the plurality of logical addresses; and
a controller suitable for controlling the memory device, the controller comprising:
a map cache table having a number of indexes; and
a processor suitable for:
determining an index, among the number of indexes, corresponding to a logical address in a command by dividing the logical address by the chunk size to determine a chunk number indicating to which chunk the logical address belongs and performing a modulo operation on the determined chunk number and the number of indexes in the map cache table, and
caching map data corresponding to the logical address in entry corresponding to the determined indexes.
